(19) United States
(12) Patent Application Publication
(10) Pub. No.: US 2002/0088301 A1
(43) Pub. Date: Jul. 11, 2002

(54) Structure of a handle and a front fork of a scooter

(76) Inventor: Ting-Hsing Chen, Tainan Hsien (TW)

Correspondence Address: ROSENBERG, KLEIN & LEE, SUITE 101, 3458 ELLICOTT CENTER DRIVE, ELLICOTT CITY, MD, 21043, US

(21) Appl. No.: 09/749,538

(22) Filed: Dec. 28, 2000

(51) Int. Cl. B62K 21/12; B62K 21/16

(52) U.S. Cl. 74/551.1; 74/551.3

(57) ABSTRACT

This invention is a renovated structure of a handle and a front fork of a scooter. The upper end of the fork comprises a pair of corresponding holes. A vertical pipe extends downwards from the center portion of the handle, which is sized to be inserted into the fork from the top end. An elastic element with its pins extrudes outwardly from a pair of preset holes on the vertical pipe and then through the holes of the fork when the vertical pipe is inserted into the fork. The fork has a cap having a through hole adapted to sleeve from the top of the fork, the hole has a flat end at one side which corresponds to the shape of the vertical pipe so that it may insert therein. Whereas the pins of the elastic element extrude through the holes of the fork to secure the handle thereat, and by pushing the pins inwardly, the handle may be departed from the fork.

### BACKGROUND OF THE INVENTION

1. Field of the Invention

This invention relates to the structure of a handle and a front fork of a scooter, more particularly to the structure with a special design for easy installation and quick mount and dismount.

2. Description of Prior Art

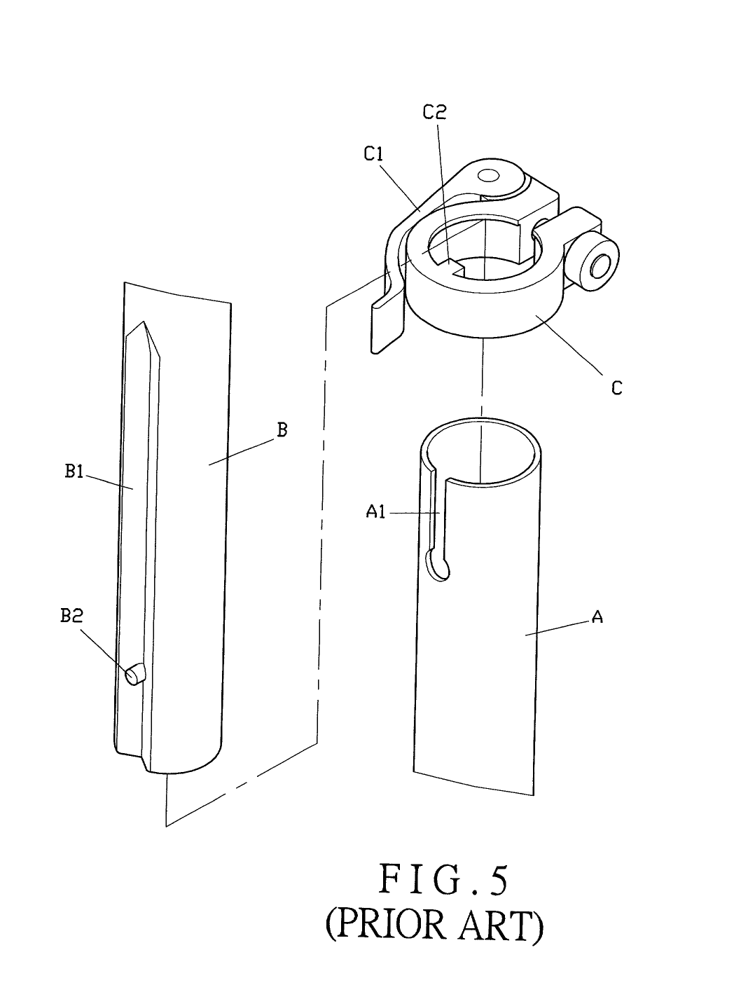

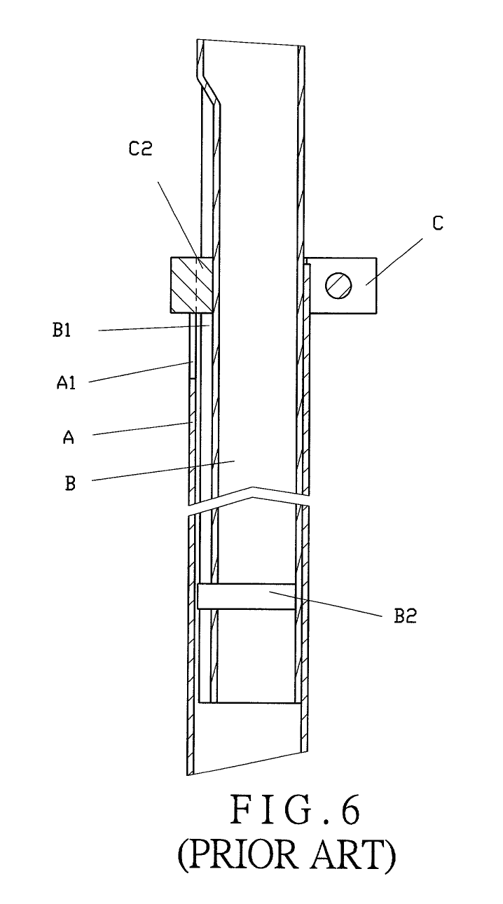

A conventional scooter or a skateboard has a large body size, which is not convenient in carrying and storage, thus, a retractable and foldable design has been adapted to minimize its size. Take the scooter as an example, the front fork is retractable which uses quick release device, as shown in FIGS. 5 and 6. The retractable structure comprises an outer pipe A with a longitudinal slot Al at the upper end, a quick release bracelet C which has a rib C2 extending inwardly to be inserted into the corresponding slot A1, and an inner tube B having a groove B1 at one side corresponding to the rib C2 and a stub B2 at the bottom portion of the groove B1. The rib C2 and the groove B1 are functioned as a guide for the inner tube B to slide in the outer pipe A, and the stub B2 is like a stopper which restricts a further movement of the inner tube B.

The above design has too much parts and the design is too complicate which is time consume and the size after retraction is still big, relatively.

### SUMMARY OF THE INVENTION

It is the primary object of the present invention to provide a structure of a handle and a fork of a scooter, which is easy to assemble and disassemble.

It is another object of the present invention to provide a handle and a fork of a scooter, which is solid and secure.

It is a further object of the present invention to provide a handle and a fork of a scooter, which requires less manpower that save cost in manufacture.

### DETAILED DESCRIPTION OF THE DRAWINGS

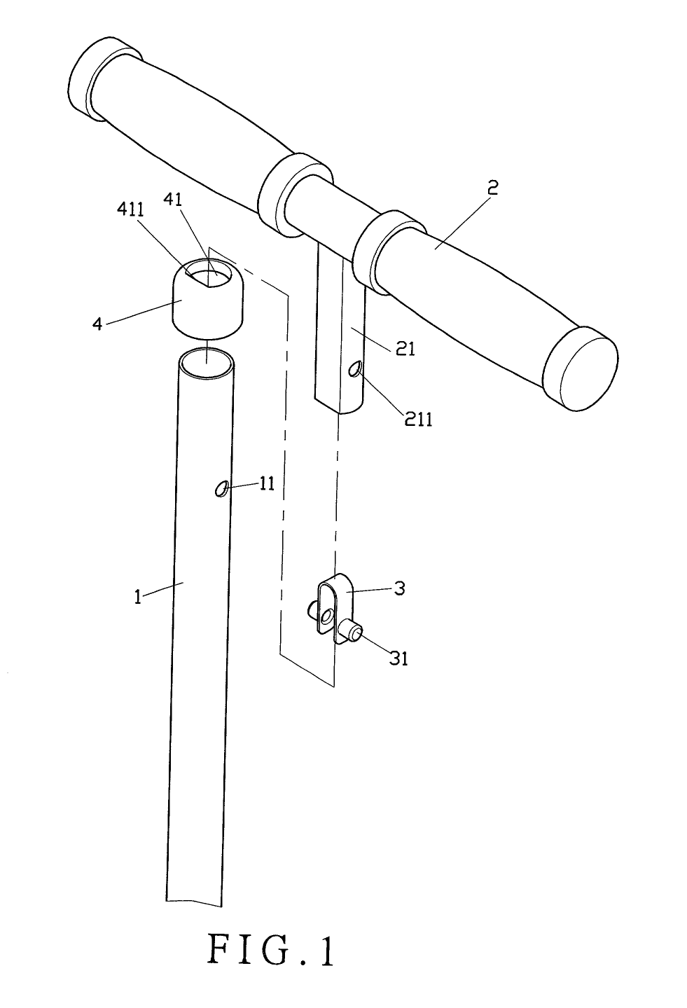

FIG. 1 is an exploded view of the present invention;

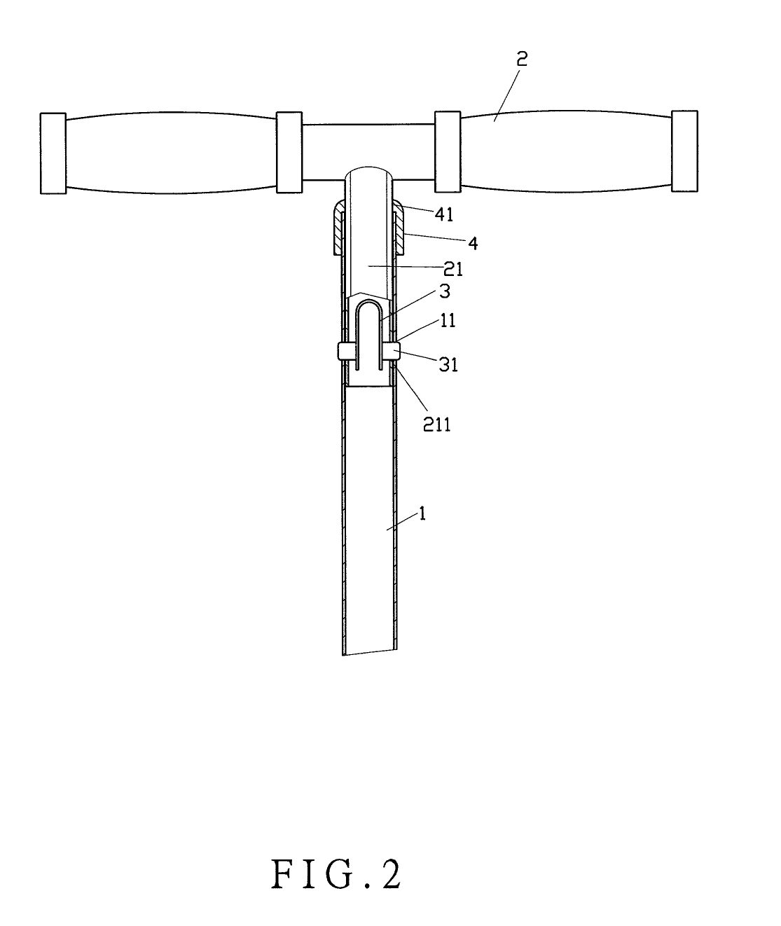

FIG. 2 is a perspective side view of FIG. 1, partially sectioned;

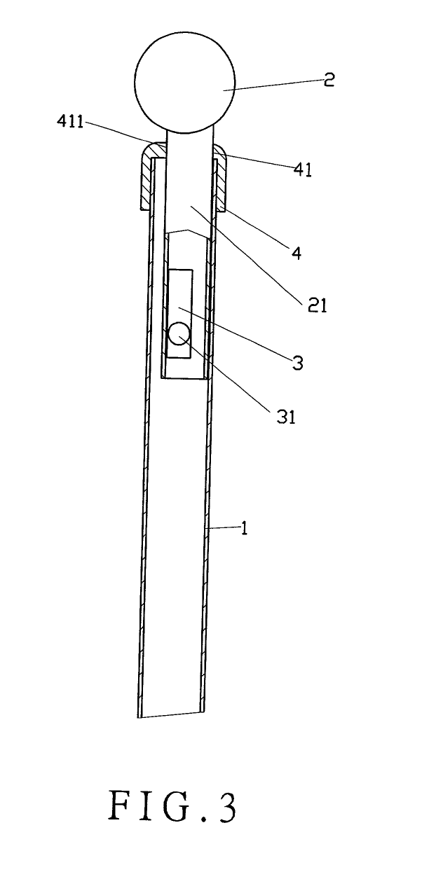

FIG. 3 is an enlarged view of FIG. 2;

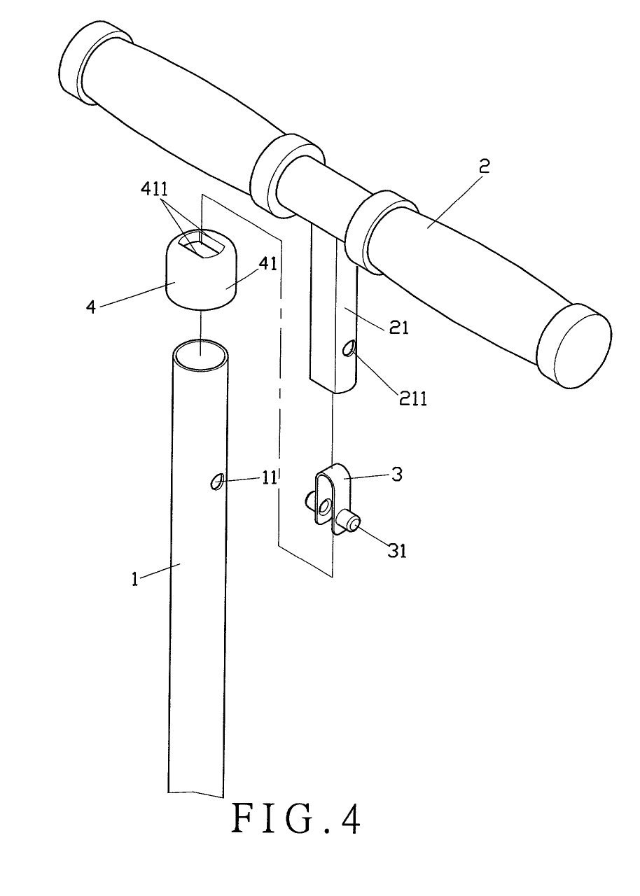

FIG. 4 is a an exploded view of another embodiment;

FIG. 5 is an exploded view of a prior art; and

FIG. 6 is a perspective side view of FIG. 5, partially sectioned.

### DETAILED DESCRIPTION OF THE PREFERRED EMBODIMENTS

As shown in FIG. 1, the present invention comprises a fork 1 and a handle 2.

The fork 1 comprises a pair of holes 11 on the upper wall corresponding to each other, and the handle 2 comprises a vertical pipe 21 extending downwardly from the center portion thereof and is to be inserted into the fork 1 from the top end. The vertical pipe 21 comprises an elastic element 3 having a pair of pins 31 which extend through a pair of holes 211 of the vertical pipe 21.

The upper end of the fork 1 has a cap 4 which has a through hole 41 having an inner diameter slightly larger than that of the outer diameter of the fork 1, the through hole 41 has a flat side 411.

FIGS. 2 and 3 show an assembled scooter of the present invention, which is done by insertion of the vertical pipe 21 through the hole 411 of the cap 4 into the fork 1. The vertical pipe 21 is guided by only one direction due to the irregular shape of the hole 411. The outer wall of the vertical pipe 21 at this moment will engage with the inner wall of the fork 1. Upon the holes 211 reach the holes 11, the pins 31 will be urged to extrude through the holes 11, thus the handle 2 and the fork 1 are secured together.

The holes 11 of the fork 1 may have more than one and in different levels, so that the height of the handle 2 is adjustable.

To disassemble the handle 2 from the fork 1, the pins 31 are pushed inwardly, thus the handle 2 may be extracted from the cap 4 and the fork 1.

Another embodiment is to form the through hole 41 of the cap 4 into a rectangle shape with two flat sides 411, and to form the vertical pipe 21 the same shape.

I claim:

1. A structure of a handle and a fork of a scooter comprising a pair of holes at top portion of said fork, said handle comprising a vertical pipe extending downwardly from a center portion thereof, and an elastic element in said vertical pipe with two pins urged to protrude from a pair of holes on said vertical pipe, and the improvements comprising
said fork comprising a cap with a through hole to be sleeved from the top end onto said fork, said through hole having at least a flat side;
said vertical pipe of said handle being shaped to match the shape of said through hole of said cap of said fork;
whereas, upon said vertical pipe being inserted into said fork through said cap, said pins of said elastic element being urged to extend through said holes of said fork to secure said handle onto said fork.
